(19) United States
(12) Patent Application Publication
(10) Pub. No.: US 2014/0211838 A1
(43) Pub. Date: Jul. 31, 2014

(54) METHOD AND APPARATUS FOR ALGORITHM ON FLEXIBLE SQUARE-QAM COHERENT DETECTION

(71) Applicant: ZTE (USA) INC., Richardson, TX (US)

(72) Inventors: Jianjun Yu, Basking Ridge, NJ (US); Bo Huang, Morristown, NJ (US)

(73) Assignee: ZTE (USA) INC., Richardson, TX (US)

(21) Appl. No.: 14/165,127

(22) Filed: Jan. 27, 2014

Related U.S. Application Data
(60) Provisional application No. 61/757,991, filed on Jan. 29, 2013.

(51) Int. Cl. H04L 25/03; H04L 27/38

(52) U.S. Cl. CPC H04L 25/03197; H04L 27/3818
USPC 375/233

(57) ABSTRACT

In Software defined elastic optical networks, modulation format and constellation size may be flexibly modified. As a result, digital signal processing (DSP) algorithm should be compatible with different modulation schemes or readily reconfigurable at the optical coherent receiver. Therefore we propose a novel cascaded adaptive blind equalizers based on decision-directed modified least mean square (DD-MLMS) algorithm for polarization separation and carrier phase recovery. The algorithm is square quadrature amplitude modulation (QAM) independent so that it could be applied in the elastic optical systems. The 28 Gbaud polarization multiplexing quadrature phase shift keying (PM-QPSK) and PM-16QAM back-to-back transmission is demonstrated. The results show that the performance is very close to the general algorithm but with a benefit of the reduced operation complexity. We transmit the 8×240 Gb/s PM-16QAM wavelength division multiplexing (WDM) signal over 1200 km standard single mode fiber (SSMF) based on the proposed blind equalization with a bit error ratio (BER) less than 2×10−2.

### CROSS-REFERENCE TO RELATED APPLICATIONS

This Application claims the benefit of U.S. Provisional Application 61/757,991 filed on Jan. 29, 2013, the entirety of which is incorporated herein by reference.

### BACKGROUND OF THE INVENTION

### I. Introduction

For 100 Gb/s and beyond optical transmission systems, the flexible and adaptive bandwidth, known as elastic bandwidth, enables to efficiently distribute data according to the needed capacity and transmission length. Consequently the software defined elastic optical networks are becoming more and more attractive and important at present [1]-[4]. In this software defined networking (SDN), modulation format and constellation size may be flexibly modified. In that case, digital signal processing (DSP) must be compatible with different modulation schemes or readily reconfigurable at the receiver. Polarization multiplexing quadrature phase shift keying (PM-QPSK) is proposed and commercially available for 100-Gb/s optical transmission system [5]. Polarization multiplexing 16-ary quadrature amplitude modulation (PM-16QAM) [6] and higher-level QAM (e.g., 36QAM) [7], [8] are proposed for beyond 100-Gb/s optical transmission system. Therefore, it is quite important to discuss the DSP compatibility for the mQAM signal especially for QPSK and 16QAM in the future elastic optical networks.

Recently, lots of algorithms have been proposed to recover the distorted signal. The static filter is used for chromatic dispersion (CD) compensation [9]. The filter parameters are dependent on the residual CD and have no relation with modulation format. The constant modulus algorithm (CMA) is well accepted to separate the two polarization components. It is proved efficient to adapt the finite impulse response (FIR) tap weights for the QPSK and m-ary phase shift keying (mPSK) signal which has constant modulus. However, CMA is not well compatible with 16QAM because high order QAM no longer presents constant symbol amplitude and equalized signal error cannot approach to zero. Instead, radius directed equalization (RDE) algorithm is proposed [10], but it needs changing with the number of radius of the constellation. For carrier recovery, Viterbi and Viterbi algorithm is useful to QPSK signal [11], while feed forward estimation is more hardware efficient for mQAM signal [12]. The common problem is that the algorithm needs re-configuration and re-initialization so they are not flexible for the dynamic modulation format deployment.

The decision-directed least radius distance (DD-LRD) algorithm for blind equalization is proposed [13], which is also named phase independent decision-directed least mean square (DD-LMS) [14]. But it is unrelated to carrier phase so that cannot be applied for carrier recovery. Although conventional DD-LMS algorithm is compatible with all kinds of modulation formats, it is too sensitive to phase error. Generally, it should be combined with CMA or RDE for pre-convergence. In this paper, we propose a novel decision-directed modified least mean square (DD-MLMS) algorithm which is suitable for square-QAM signal. Besides, carrier phase is blindly recovered simultaneously because phase error is reserved in the cost function. Low complex cascaded DD-MLMS based adaptive equalizers are applied for polarization separation and carrier phase recovery in the flexible square-QAM coherent optical systems for the elastic optical networks.

### BRIEF DESCRIPTION OF THE DRAWINGS

The accompanying drawings are included to provide a further understanding of the invention, and are incorporated in and constitute a part of this specification. The drawings illustrate disclosed embodiments and/or aspects and, together with the description, serve to explain the principles of the invention, the scope of which is determined by the claims.

FIG. 1 illustrates a DD-MLMS based adaptive FIR equalizer;

FIG. 2 illustrates cascaded adaptive equalizers with DD-MLMS;

FIG. 3 is a chart showing Q value versus product of laser linewidth and symbol duration Δν·Tₛ. Inset is the 16QAM constellations of received signal and processed signal based on proposed algorithm;

FIG. 4 illustrates an experimental setup where CW: continuous wave, I/Q mod.: I/Q modulator, ATT: attenuator, OBPF: optical band-pass filter, LO: local oscillator;

FIG. 5 illustrates measured BER as a function of OSNR (0.1 nm). Inset is the QPSK constellations of recovered signal based on different methods which is measured at an OSNR of 15 dB;

FIG. 6 illustrates measured BER as a function of OSNR (0.1 nm). Inset is the 16QAM constellations of recovered signal based on different methods which is measured at an OSNR of 25 dB; and

FIG. 7 illustrates measured BER as a function of transmission length for 16QAM signal.

### DETAILED DESCRIPTION OF THE INVENTION

It is to be understood that the figures and descriptions provided herein may have been simplified to illustrate elements that are relevant for a clear understanding of the present invention, while eliminating, for the purpose of clarity, other elements found in typical algorithms on flexible square-QAM coherent detection systems and methods. Those of ordinary skill in the art may recognize that other elements and/or steps may be desirable and/or necessary to implement the devices, systems, and methods described herein. However, because such elements and steps are well known in the art, and because they do not facilitate a better understanding of the present invention, a discussion of such elements and steps may not be provided herein. The present disclosure is deemed to inherently include all such elements, variations, and modifications to the disclosed elements and methods that would be known to those of ordinary skill in the pertinent art of optical network operation.

### II. Operation Principle

We may model the fiber optics channel simply by a unitary 2×2 matrix considering CD, polarization mode dispersion (PMD) and carrier phase as shown in (1),

$$[ \begin{matrix}{z}_{x} \\ {z}_{y}\end{matrix} ] = {h}_{cd} [ \begin{matrix}cos θ & {e}^{- j φ} sin θ \\ - {e}^{j φ} sin θ & cos θ\end{matrix} ] [ \begin{matrix}{e}^{j {ϕ}_{x}} & 0 \\ 0 & {e}^{j {ϕ}_{y}}\end{matrix} ] [ \begin{matrix}{s}_{x} \\ {s}_{y}\end{matrix} ] \qquad ( 1 )$$

where h_{cd} is the fiber transfer function under dispersion. 2θ and ø are the azimuth and elevation rotation angles, respectively. φₓ and φ_{y} are the carrier phase offset. With respect to (1), we can recover the signal with the digital FIR equalizer.

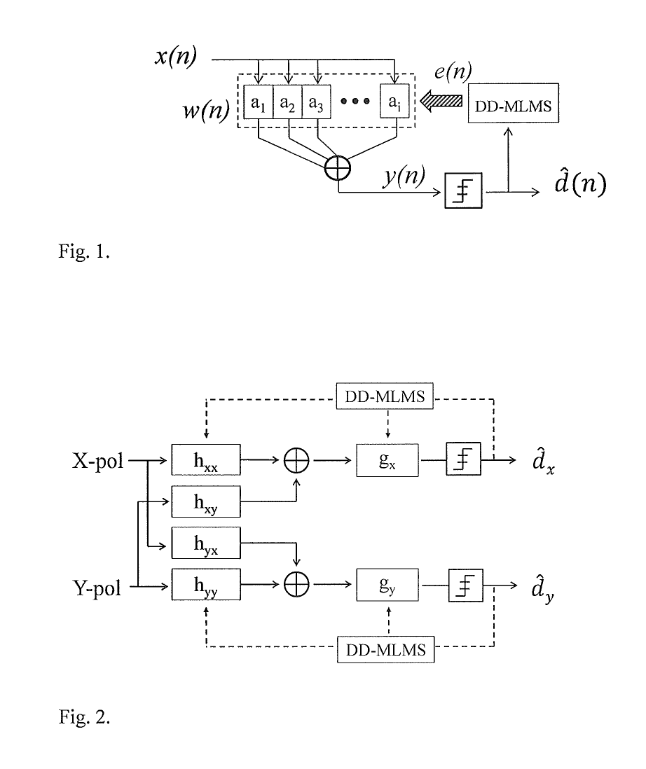

As we know, adaptive FIR filter is a popular blind equalizer for intersymbol interference (ISI) mitigation, polarization separation, and carrier phase tracking. The equalizer coefficients will be updated adaptively using a cost function according to a priori knowledge of the symbol character. FIG. 1 illustrates our proposed novel FIR blind equalizer with DD-MLMS algorithm to adapt the filter tap coefficients. x(n) is the received signal data. w(n)=[a₁, a₂, . . . aᵢ] is the tap coefficients vector. We obtain the equalized signal by y(n)=w(n)^{T}x(n), where superscript T stands for the transposition of a vector. The decision symbol is \hat{d}(n) decided by the shortest distance away from mQAM constellation point. DD-MLMS algorithm is proposed for the adaptive equalizer to minimize the mean square error. Since the mQAM signal constellation is square like, multi-modulus cost functions on both real axis and imaginary axis are considered. Meanwhile we want to reserve not only the amplitude error information but also the phase error information. Thus, the error function is divided into two parts. The errors of real part and imaginary part are calculated separately. Equations (2) and (3) show the error functions of real part and imaginary part, respectively,

eᵣ(n)=(|\hat{d}ᵣ(n)|²−|yᵣ(n)|²)×sgn[yᵣ(n)] (2)

eᵢ(n)=(|\hat{d}ᵢ(n)|²−|yᵢ(n)|²×sgn(yᵢ(n)) (3)

e(n)=eᵣ(n)+j·eᵢ(n) (4)

where the signum function is defined as sgn(x)=x/|x|. The error functions of real part and imaginary part are then combined together, which is expressed as a complex error vector as shown in (4).

The filter tap weights updating equation is shown in (5).

w(n)=w(n−1)+μe(n)×(n)* (5)

where w(n) is the adaptive FIR filter, and μ is the convergence parameter. [•]* stands for conjugation operation.

Since real part and imaginary part of the equalizer output are estimated respectively, the DD-MLMS algorithm tries to force the equalized signal to reside on the decision point. In addition, the error function includes both amplitude and phase information of the equalized signal. As a result, carrier phase offset is also blindly compensated.

In order to realize polarization separation and carrier phase recovery which is transparent to mQAM modulation format in the elastic optical networks, we propose cascaded DD-MLMS based adaptive equalizers. FIG. 2 shows the DSP of this blind equalization. The cascaded adaptive blind equalizers consist of four butterfly FIR filters (hₓₓ, h_{xy}, h_{yx}, h_{yy}) for polarization separation and two FIR filters (gₓ, g_{y}) for carrier phase recovery. All of the filters are adaptively updated by DD-MLMS. It should be pointed out that all the signal processing is modulation format independent for square-QAM signal except for symbol final decision. Nevertheless, symbol decision must be required in any situation and format dependence is inevitable for the final decision.

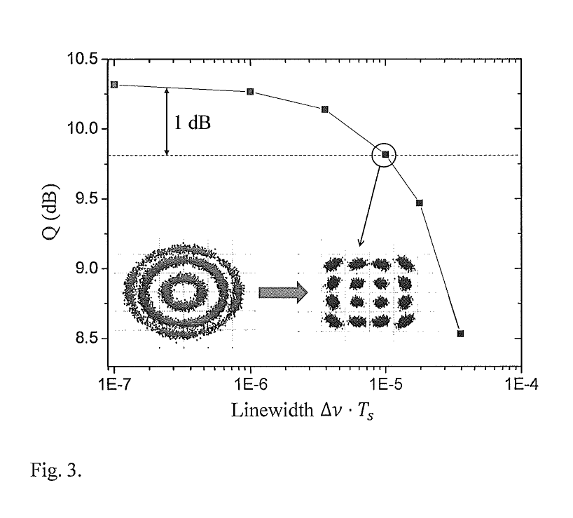

Numerical simulation is done in order to evaluate the performance of our proposed algorithm. We take 16QAM signal as an example. The initial carrier phase offset is 45°. The inset constellations in FIG. 3 present that the signal carrier phase is successfully recovered and the influence of the phase noise due to laser linewidth is reduced thanks to the blind equalizer. The curve of the measured Q value versus linewidth and symbol duration product is shown in FIG. 3. The algorithm can tolerate Δν·Tₛ of 1E-5 with Q penalty of 1 dB.

### III. Experiment and Discussion

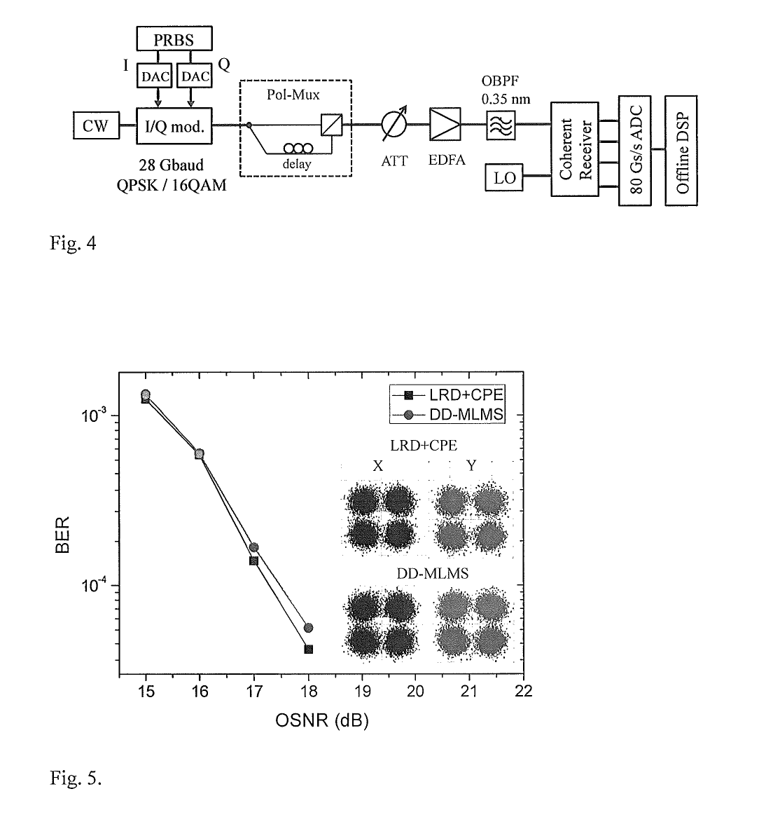

FIG. 4 shows the experimental setup of 28 Gbaud PM-QPSK and PM-16QAM back-to-back transmission. The bit sequence with a pseudo-random binary sequence (PRBS) length of 212 is coded by applying Gray-mapping for QPSK and 16QAM. The 28 Gbaud electrical signals are generated with two digital-to-analog converters (DACs) with a bandwidth of 16 GHz for in-phase (I) and quadrature (Q) branches. An external cavity laser (ECL) is used as the continuous wave (CW) source and modulated by an I/Q modulator biased at null point. Hence the modulation format of QPSK or 16QAM can be defined by the software. The signal is polarization multiplexed with a differential delay of 150 symbols between two polarizations. Therefore, the bit-rate is 112 Gb/s when QPSK is deployed and 224 Gb/s when 16QAM is deployed. A variable attenuator and an Erbium Doped Fiber Amplifier (EDFA) are used to control the optical signal-to-noise ratio (OSNR) of the received signal. After that, one tunable optical band-pass filter (OBPF) with 3-dB bandwidth of 0.35 nm is tuned at measured wavelength. Polarization diversity homodyne detection is utilized at the receiver. The linewidth of ECLs at the transmitter and for LO at the receiver are both smaller than 100 kHz. We apply 80-GSa/s sampling and 30-GHz bandwidth analog-to-digital converters (ADCs) in the oscilloscope. The received data is then offline digital processed by a computer.

The received signal is resampled to 2 times of the symbol rate by cubic interpolation with square timing method [15]. As described in section II, cascaded FIR equalizers are used to blindly recover the signal. Four 9-tap T/2-spaced adaptive butterfly FIR filters are applied for polarization demultiplexing. Afterward two 9-tap T-spaced adaptive FIR filters are applied for carrier recovery. The filters' weights are first updated by CMA for pre-convergence. The final adaptation is switched to DD-MLMS for precise feedback control. Frequency offset is compensated based on the fast Fourier transform (FFT) method [16] which is also modulation format independent. Finally, the signal is detected for data bit error ratio (BER) measurement. As a comparison, DD-LRD scheme together with general carrier phase estimation (CPE) (Viterbi-and-Viterbi algorithm for QPSK signal and feed forward estimation algorithm for 16QAM signal) is also evaluated.

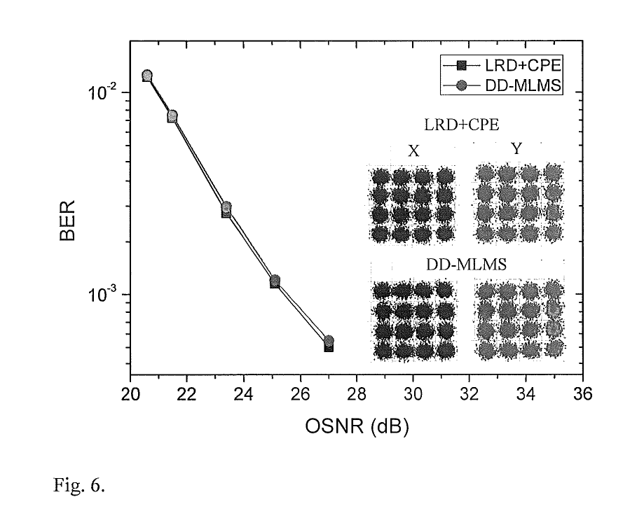

The measured BERs of QPSK and 16QAM signals as a function of OSNR are shown in FIG. 5 and FIG. 6, respectively. The OSNR is measured in a 0.1-nm noise bandwidth. Compared to the general algorithm and proposed algorithm processed with the same measured data, the BER performance of DD-MLMS processing is nearly the same as the LRD+CPE processing. The OSNR penalty is less than 0.5 dB for QPSK and 16QAM signals. The proposed algorithm works well enough and comparably with conventional algorithm but the complexity is reduced and compatible with both QPSK and 16QAM formats in our experiment.

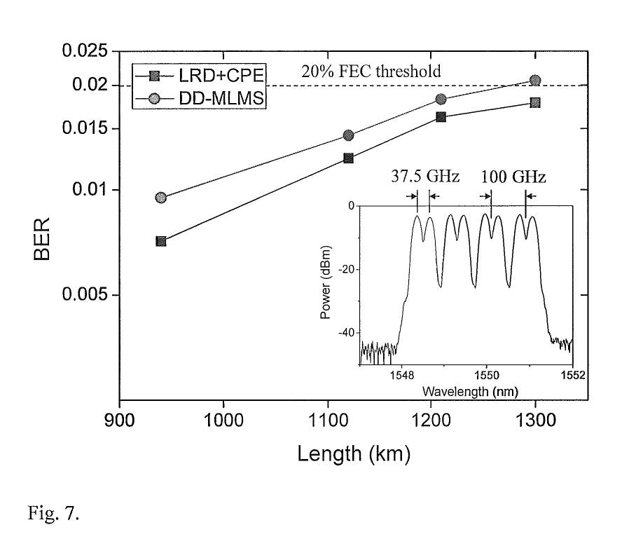

We carry out 8×240 Gb/s PM-16QAM wavelength division multiplexing (WDM) transmission experiment over different length standard single mode fibers (SSMF). The spectrum of the signal is shown in FIG. 7 inset. The launched power is 0 dBm per channel. The amplifier span is 80 km SMF-28 with span loss of 18 dB. CD compensation algorithm is applied in DSP. The BER performance versus fiber length is shown is FIG. 7. The BER increases with the transmission length because the signal OSNR decreases and fiber nonlinearity accumulates. Using the proposed algorithm, the BER performance is a little worse than that using general LRD+CPE algorithm. The transmission length can achieve 1200 km with a BER less than 2×10−2, which is forward error correction (FEC) limitation with 20% overhead.

The final symbol decision is constellation dependent right now. In order to realize the practical and really full blind DSP to unknown received signals, we must figure out this problem. One of the methods is that we can estimate the signal format by the statistics after pre-equalization such as CMA. This issue will be studied in the future.

### IV. Conclusion

We propose a novel cascaded adaptive equalizers based on DD-MLMS algorithm for the future elastic optical networks. The DSP is compatible with square-QAM signal. So it could be deployed in the flexible mQAM modulation format coherent optical systems. We demonstrate the 28 Gbaud dual polarization QPSK signal and 16QAM signal back-to-back transmission. The results show that the performance is very close but the complexity is much reduced compared to the general algorithm. The 8 channel WDM 240 Gb/s/ch PM-16QAM signal transmission with different fiber length is demonstrated. The transmission length can achieve 1200 km with a BER less than 2×10−2 based on the proposed blind equalization.

Although the invention has been described and illustrated in exemplary forms with a certain degree of particularity, it is noted that the description and illustrations have been made by way of example only. Numerous changes in the details of construction and combination and arrangement of parts and steps may be made. Accordingly, such changes are intended to be included in the invention, the scope of which is defined by the claims.

### REFERENCES

[1] O. Gerstel, M. Jinno, A. Lord, and S. J. B. Yoo, “Elastic optical networking: a new dawn for the optical layer?” IEEE Commun. Mag., vol. 50, no. 2, pp. s12-s20, February 2012.
[2] H. Y. Choi, T. Tsuritani, and I. Morita, “BER-adaptive flexible-format transmitter for elastic optical networks,” Opt. Express, vol. 20, no. 17, pp. 18652-18658, August 2012.
[3] R. Borkowski, et al., “Experimental study on OSNR requirements for spectrum-flexible optical networks,” J. Opt. Commun. Netw., vol. 4, no. 11, pp. B85-B93, November 2012.
[4] Y.-K. Huang, et al., “High-capacity fiber field trial using terabit/s all-optical OFDM superchannels with DP-QPSK and DP-8QAM/DP-QPSK modulation,” J. Lightw. Technol., vol. 31, no. 4, pp. 546-553, February 2013.
[5] K. Roberts, M. O'Sullivan, K.-T. Wu, H. Sun, A. Awadalla, D. J. Krause, and C. Laperle, “Performance of dual-polarization QPSK for optical transport systems,” J. Lightw. Technol., vol. 27, no. 16, pp. 3546-3559 May 2009.
[6] P. J. Winzer, A. H. Gnauck, S. Chandrasekhar, S. Draving, J. Evangelista, and B. Zhu, “Generation and 1,200-km transmission of 448-Gb/s ETDM 56-Gbaud PDM 16-QAM using a single I/Q modulator,” in Proceedings of ECOC2010, Torino, Italy, Paper PDP 2.2.
[7] X. Zhou, et al., “64-Tb/s, 8 b/s/Hz, PDM-36QAM transmission over 320 km using both pre- and post-transmission digital signal processing,” J. Lightw. Technol., vol. 29, no. 4, pp. 571-577, February 2011.
[8] J. Yu, Z. Dong, H.-C. Chien, Y. Shao, and N. Chi, “7-Tb/s (7×1.284 Tb/s/ch) signal transmission over 320 km using PDM-64QAM modulation,” IEEE Photon. Technol. Lett., vol. 24, no. 4, pp. 264-266, February 2012.
[9] S. J. Savory, “Digital filters for coherent optical receivers,” Opt. Express, vol. 16, no. 2, pp. 804-817, January 2008.
[10] I. Fatadin, D. Ives, and S. J. Savory, “Blind equalization and carrier phase recovery in a 16-QAM optical coherent system,” J Lightw. Technol., vol. 27, no. 15, pp. 3042-3049, August 2009.
[11] A. J. Viterbi and A. M. Viterbi, “Nonlinear estimation of PSK-Modulated carrier phase with application to burst digital transmission,” IEEE Trans. Inf. Theory, vol. 29, no. 4, pp. 543-551, July 1983.
[12] T. Pfau, S. Hoffmann, and R. Noe, “Hardware-efficient coherent digital receiver concept with feedforward carrier recovery for M-QAM constellations,” J. Lightw. Technol., vol. 27, no. 8, pp. 989-999, April 2009.
[13] X. Xu, B. Chatelain, and D. V. Plant, “Decision directed least radius distance algorithm for blind equalization in a dual-polarization 16-QAM system,” in Proceedings of OFC2012, L. A., Paper OM2H.
[14] P. J. Winzer, A. H. Gnauck, C. R. Doerr, M. Magarini, and L. L. Buhl, “Spectrally efficient long-haul optical networking using 112-Gb/s polarization-multiplexed 16-QAM,” J. Lightw. Technol., vol. 28, no. 4, pp. 547-556, February 2010.
[15] M. Oderder, and H. Meyr, “Digital filter and square timing recovery,” IEEE Transac. Commun., vol. 36, no. 5, pp. 605-612, May 1988.
[16] M. Selmi, Y. Jaouen, P. Ciblat, “Accurate digital frequency offset estimator for coherent PolMux QAM transmission systems,” in Proceedings of ECOC2009, Vienna, Austria, Paper P3.08.

What is claimed as new and desired to be protected by Letters Patent of the United States is:

1. A decision-directed modified least mean square (DD-MLMS) method comprising:
receiving a data signal; and
equalizing the data signal using an adaptive finite impulse response filter having multiple TAP coefficients, wherein the TAP coefficients are adaptively updated using a DD-MLMS algorithm and a cost function according to earlier symbol character information.

2. The method of claim 1, wherein the DD-MLMS algorithm minimizes mean square error.

3. The method of claim 1, wherein the cost function is multi-modulus on both a real signal part and an imaginary signal part.

4. The method of claim 1, further comprising
reserving amplitude error information and phase error information; and
calculating separately, and then combining, errors of a real signal part and an imaginary signal part.

5. The method of claim 4, further comprising estimating a real part of an output signal and an imaginary part of an output signal.

6. A decision-directed modified least square mean (DD-MLMS) system comprising:
a filter adapted to receive a data signal and equalize the data signal using an adaptive finite impulse response filter having multiple TAP coefficients, wherein the TAP coefficients are adaptively updated using a DD-MLMS algorithm and a cost function according to earlier symbol character information.

7. The system of claim 6, wherein the DD-MLMS algorithm minimizes mean square error.

8. The system of claim 6, wherein the cost function is multi-modulus on both a real signal part and an imaginary signal part.

9. The system of claim 6, wherein the filter is further adapted to:
reserve amplitude error information and phase error information; and
calculate separately, and then combine, errors of a real signal part and an imaginary signal part.

10. The method of claim 9, further comprising estimating a real part of an output signal and an imaginary part of an output signal.

11. A decision-directed modified least square mean (DD-MLMS) system comprising: a plurality of cascaded adaptive blind equalizers comprising multiple finite impulse response filters for polarization and multiple finite impulse response filters for carrier phase recovery, wherein the finite impulse response filters are capable of being adaptively updated by DD-MLMS.

12. The system of claim 11, wherein DD-MLMS minimizes mean square error.

13. The system of claim 11, wherein signal processing within the plurality of cascaded adaptive blind equalizers is modulation format independent for a square-QAM signal with the exception of a required symbol final decision.
